(19) United States
(12) Patent Application Publication
(10) Pub. No.: US 2011/0076964 A1
(43) Pub. Date: Mar. 31, 2011

(54) Re-Activation of a Base Station in Standby Mode

(76) Inventors: Martin Dottling, Neubiberg (DE); Michael Faerber, Wolfratshausen (DE); Kari Juhani Hooli, Oulu (FI); Andreas Lobinger, Grafing (DE); Juergen Michel, Munich (DE); Kari Pekka Pajukoski, Oulu (FI); Bernhard Raaf, Neuried (DE); Esa Tapani Tiirola, Kempele (FI)

(21) Appl. No.: 12/993,930

(22) PCT Filed: Jun. 11, 2008
(86) PCT No.: PCT/EP2008/004688

§ 371 Date: Nov. 22, 2010

(30) Foreign Application Priority Data
May 23, 2008 (EP) 08009503.7

(51) Int. Cl. H04B 7/00

(52) U.S. Cl. 455/68

(57) ABSTRACT

The present invention relates to methods, apparatuses, a system and a computer program product for reducing a power consumption in low load scenarios. An apparatus can include transmitting means, receiving means and determining means for determining whether a signal quality of a broadcast channel of a wireless network cell is insufficient, wherein the transmitting means may transmit on a wireless access channel an activation information to a further apparatus if the determination is affirmative. The activation information can indicate that disabled transmitting means of the further apparatus should be re-enabled. The further apparatus may include transmitting means, receiving means disabling means for disabling the transmitting means and enabling means for re-enabling the transmitting means, wherein the receiving means can be configured to receive the activation in-formation, and wherein the enabling means may be configured to re-enable the transmitting means if the activation information is received.

### FIELD OF THE INVENTION

The present invention relates to methods, apparatuses, a computer program product and a system for reducing a power consumption of a wireless device in low load scenarios.

### BACKGROUND OF THE INVENTION

Advanced technologies for mobile wireless communications are being developed in order to cope with increasing demands regarding improved efficiency, lower costs, improved services, usage of new spectrum opportunities, better integration with other open standards and so on. For example, 3rd generation partnership project (3GPP) long-term evolution (LTE) and LTE advanced (LTE-A) are approaches to providing next generation mobile wireless broadband technology. For future and present wireless networks, automated configuration and optimization such as e.g. energy optimization is of concern to reduce a total cost of ownership for operators of the networks.

A base station of a current wireless communication system such as e.g. a global system for mobile communications (GSM) base transceiver station (BTS) or a universal mobile telecommunications system (UMTS) node B has a remarkable power consumption, and generates a significant operating or operational expenditure (OPEX) by its power consumption. Besides of the cost aspect for the operator, the electromagnetic radiation and possible adverse health effect as well as the ecological impact should be considered. This also applies to e.g. an enhanced node B (eNB) or home enhanced node B (H(e)NB) according to 3GPP LTE or LTE-A. For example, the power consumption of a H(e)NB can cause significant costs if there is no efficient standby mode solution applied in case of service inactivity.

Previously proposed base stations are not or little adaptive to their traffic needs. Further, the base stations even totally unloaded consume a lot of primary energy. This is mainly due to the power amplifier with its linear requirements, caused by the applied transmission technology. It requires a minimum current driven through the amplifier transistors in order to set the operational point in such a way that the required linear behavior can be achieved. Even in case of an unloaded operating state the power consumption remains high.

Current implementations of base stations have about a factor of two between power consumptions for a fully loaded wireless network cell and an unloaded wireless network cell. A significant part of the load-independent power consumption socket is contributed by the power amplifier. Further, the permanent operation of controller and baseband processing cards contributes to the power consumption. The transmitter part, in particular the high power amplifier, is a top contributor to power consumption. However, digital and analogue transmitter signal pre-distortion also consumes power.

In offload or low load operational periods, e.g. during night time, the power consumption remains while probably only few users are served. In an extreme case, there is no active user at all, but the power consumption is still quite high. This keeps the OPEX high, and the eco-balance bad. In capacity-driven systems, the base station density is high. Therefore, in principle some of the base stations may be entirely turned or switched off, assuming that the other base stations can partly take over a coverage. In this case, a problem with the uplink (UL) can arise. The output power of a mobile terminal device is limited, and the battery capacity prevents a simple solution like the increase of the mobile terminal device's transmit power. Thus, the uplink might be difficult if one or more base stations close to the mobile terminal device are switched off.

Hence, at present base stations in a wireless network such as e.g. node Bs, eNBs and H(e)NBs are continuously operated. If a base station should be switched off, manual procedures and re-configurations or operation & maintenance (O&M) configurations are needed. The mobile terminal device's uplink limitation in transmit power may cause an imbalance between UL and downlink (DL).

Further, a re-activation of a switched off base station would require a special formed UL signal. This enhances range capabilities of the mobile terminal device, and requires a specific receiver in active base stations to detect this special formed signal.

In addition to automated configuration and optimization, a network behavior in emergency situations is of concern for future and present wireless networks. For example, in case of an emergency call it should be possible to re-activate an eNB or H(e)NB that is in a standby mode, even if a mobile terminal device initiating the emergency call is not in a home zone of the eNB or H(e)NB and member of its closed subscriber group.

### SUMMARY OF SOME EXAMPLES OF THE INVENTION

It is an object of the present invention to provide a mechanism for reducing a power consumption without requiring a special formed UL signal or specific receiver.

This object can be achieved at a first transmission end by a method comprising:
disabling transmitting means of an apparatus comprising the transmitting means and receiving means, the transmitting means being configured to transmit a wireless communication signal and the receiving means being configured to receive a wireless communication signal;
receiving by the receiving means an activation information indicating that the transmitting means should be re-enabled; and
re-enabling the transmitting means if the activation information is received in the receiving step.

Furthermore, at a second transmission end the above object may be achieved by a method comprising:
determining whether a signal quality of a broadcast channel of a wireless network cell is insufficient; and
transmitting on a wireless access channel an activation information to an apparatus, if the determination in the determining step is affirmative, the activation information indicating that disabled transmitting means of the apparatus should be re-enabled.

Moreover, at the first transmission end the above object can be achieved by an apparatus comprising:
transmitting means for transmitting a wireless communication signal;
receiving means for receiving a wireless communication signal;
disabling means for disabling the transmitting means; and
enabling means for re-enabling the transmitting means,
wherein the receiving means is configured to receive an activation information indicating that the transmitting means should be re-enabled, and
wherein the enabling means is configured to re-enable the transmitting means if the activation information is received by the receiving means.

In addition, at the second transmission end the above object can be achieved by an apparatus comprising:
transmitting means for transmitting a wireless communication signal;
receiving means for receiving a wireless communication signal; and
determining means for determining whether a signal quality of a broadcast channel of a wireless network cell is insufficient,
wherein the transmitting means is configured to transmit on a wireless access channel an activation information to a further apparatus, if the determination of the determining means is affirmative, the activation information indicating that disabled transmitting means of the further apparatus should be re-enabled.

The above methods may be implemented as a computer program product comprising code means for performing the respective above steps when run on a computer device.

The above apparatuses may be implemented as network elements or nodes, access devices such as e.g. base stations, fixed or mobile terminal devices, or as modules, chips, chip sets or chip devices provided in these elements, nodes or devices.

Accordingly, a mechanism can be provided that enables to disable or to switch off entire transmitter chains of sectors and/or entire access devices such as e.g. base stations, whereas receiver chains are kept activated. An activation information may be received by a receiver remaining active. The activation information can be transmitted in a usual transmission form. Thus, there is no need for a signal of a special form and/or a specific receiver in a base station. As a result, a power consumption of an access device such as e.g. a base station or a home base station and the overall power consumption in a network can be reduced without the above-mentioned specific measures. Further, there is no need for an extended range of a device at the other transmission end such as e.g. a mobile terminal device trying to access a base station. As a result, the OPEX and the eco-balance may be improved, without disadvantages as caused by previously proposed solutions.

In addition, in case of an emergency call it is possible to re-activate an access device such as e.g. an eNB or H(e)NB that is in a standby mode, even if a mobile terminal device initiating the emergency call is not in a home zone of the eNB or H(e)NB and member of its closed subscriber group. The procedure can be enhanced in a manner such that in case of emergency a re-activation signal contains an element that identifies the re-activation signal as caused by an emergency call. If this signal is system specific, not network and operator specific, the signal may re-activate any sleeping eNB or H(e)NB, independent of the service provision relationship the user has with the operator who owns the network element.

Further advantageous modifications are defined in the dependent claims.

The above examples are intended to be merely exemplary and should not be construed as limiting in any way.

### BRIEF DESCRIPTION OF THE DRAWINGS

The present invention will now be described based on embodiments with reference to the accompanying drawings, in which:

FIG. 1 shows a schematic diagram of a general network architecture in which the embodiments can be implemented;

FIG. 2 shows schematic block diagrams of apparatuses such as e.g. a terminal device and base stations according to the embodiments;

FIG. 3 shows a flow diagram of a basic processing at an apparatus such as e.g. a base station according to the embodiments;

FIG. 4 shows a flow diagram of a basic processing at an apparatus such as e.g. a terminal device according to the embodiments;

FIG. 5 shows a schematic diagram illustrating cells of a wireless network in a normal or high load scenario;

FIG. 6 shows a schematic diagram illustrating the cells of the wireless network in a low load scenario;

FIG. 7 shows a schematic diagram illustrating a synchronization of a terminal device located in a cell with a disabled transmitting unit;

FIG. 8 shows a schematic diagram illustrating a transmission of an activation information from the terminal device to the cell with the disabled transmitting unit;

FIG. 9 shows a schematic diagram illustrating a situation where a receive only cell informs an operation & maintenance center; and

FIG. 10 shows a schematic block diagram of a software-based implementation of the embodiments.

### DESCRIPTION OF EMBODIMENTS

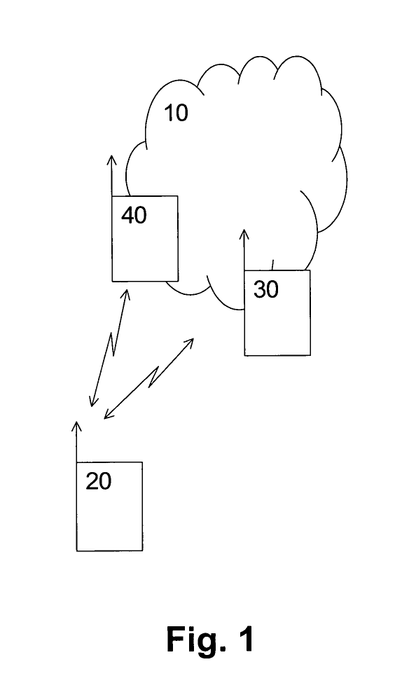

FIG. 1 shows a schematic diagram of a general network architecture in which the embodiments can be implemented. A wireless network 10 such as e.g. a GSM network or a cellular UMTS terrestrial radio access network (UTRAN) according to 3GPP LTE or LTE-A can provide access to an apparatus such as e.g. a user equipment (UE), a mobile station (MS), or a fixed or mobile terminal device 20. Access may be obtained via apparatuses like a first access device or network device 30 such as e.g. a GSM, UMTS or LTE base station device and a second access device or network device 40 such as e.g. a GSM, UMTS or LTE base station device. For example, each of the network devices 30 and 40 can be a base station device such as e.g. an eNB or H(e)NB according to LTE or LTE-A. It is noted that other apparatuses may be provided, which are not shown in FIG. 1.

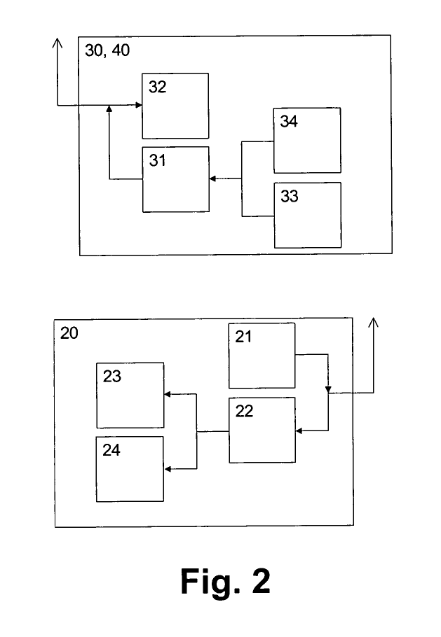

FIG. 2 shows schematic block diagrams of apparatuses such as e.g. a terminal device 20 and base stations 30, 40 according to the embodiments. In FIG. 2, a mobile terminal device 20 and a base station 30, 40 are depicted as examples of the apparatuses. However, the apparatuses may not only be implemented in this form but also e.g. as network elements or nodes, access devices, fixed terminal devices etc., or as modules, chips, chip sets or chip devices provided in such elements, nodes or devices.

The terminal device 20 may comprise a transmitting unit or means 21, a receiving unit or means 22, a determining unit or means 23, and a detecting unit or means 24. The transmitting unit 21 can transmit a wireless communication signal via an antenna, the receiving unit 22 may receive a wireless communication signal via the antenna, the determining unit 23 can determine whether a signal quality of a broadcast channel (BCH) of a wireless network cell is insufficient, and the detecting unit 24 may detect whether a suitable wireless network such as e.g. the wireless network 10 is available. The functionality of these components is described in further detail below. All or part of the components can be integrated in a single component, even if they are represented by separate blocks in FIG. 2. For example, the transmitting unit 21 and the receiving unit 22 can be integrated in a transceiver, the determining unit 23 and the detecting unit 24 may be integrated in a processor or controller, and all of the components can be integrated in a single module or chip. Further, the terminal device 20 may comprise additional components not depicted in FIG. 2. For example, it can include a storing unit such as e.g. a memory for storing received information such as e.g. the system information described below.

The base station 30, 40 may comprise a transmitting unit or means 31, a receiving unit or means 32, a disabling unit or means 33, and an enabling unit or means 34. The transmitting unit 31 can transmit a wireless communication signal via an antenna, the receiving unit 32 may receive a wireless communication signal via the antenna, the disabling unit 33 can disable the transmitting unit 31, and the enabling unit 34 may re-enable the transmitting unit 31. The functionality of these components is described in further detail below. All or part of the components can be integrated in a single component, even if they are represented by separate blocks in FIG. 2. For example, the transmitting unit 31 and the receiving unit 32 can be integrated in a transceiver, the disabling unit 33 and the enabling unit 34 may be integrated in a processor or controller, and all of the components can be integrated in a single module or chip. Further, the base station 30, 40 can comprise additional components not depicted in FIG. 2. For example, it may include a storing unit such as e.g. a memory for storing received information such as e.g. the activation information described below.

According to the embodiments, a concept is introduced, where the wireless network 10 network can disable, turn off or switch off entire transmitter chains of sectors and/or entire base stations, whereas receiver chains remain activated. A capability message, capability signal or capability information indicating the capability to disable transmitter parts can be broadcasted by network devices such as e.g. the base stations 30, 40. For example, a capability information indicating that the transmitting unit 31 is capable of being disabled may be broadcasted by means of the transmitting unit 31. In other words, cell disable capability information can be broadcasted on the BCH of a cell associated with the transmitting unit 31. In this way, terminal devices such as e.g. the terminal device 20 can be informed on the possibility that there may be network devices with disabled transmitter parts.

A lifetime message, lifetime signal or lifetime information may be broadcasted by the base stations 30, 40, i.e. the transmitting unit 31. The lifetime information can define a validity of the capability information, i.e. how long the capability information is valid, and may be broadcasted together with the capability information. That is, a signaling information (and probably also a lifetime information about message validity) can be added beforehand to broadcast information of all cells of a region, which indicates for a service area that cells can be disabled in that region.

Further, a wake up information or activation information to be transmitted to the base stations 30, 40 in order to effect re-enabling of a disabled transmitting unit thereof may be broadcasted. There are multiple options for the activation information, i.e. related system information. In general, random access channel (RACH) messages or RACH bursts with specific assigned preamble sequences can be used to transmit activation information for waking up or re-enabling a base station downlink transmitter or transmitting unit. According to a first option, a specific assigned preamble sequence or preamble sequence set that is exclusively used for wake up RACH messages may be applied. That is, each base station can have its own unique activation information. According to a second option, a same RACH preamble sequence set may be used for wake up in the whole wireless network 10, and then no further signaling can be needed on that. That is, a common activation information of a plurality of base stations may be applied.

An additional information such as e.g. an attempt information may contain an information for the terminal device 20 how long and intense the terminal device 20 shall try to synchronize and send activation information. This limitation can help in preventing that the terminal device 20 drains out its battery by infinitely sending activation information and doing excessive cell search activities when being constantly out of coverage.

The above-described system information, i.e. capability information, lifetime information and attempt information, as well as related system information such as e.g. the activation information may be broadcasted e.g. on a broadcast control channel (BCCH). However, system information may or may not contain information about an existence of sleeping base stations in the service area.

According to a first embodiment, the system information does not contain capability information. Thus, the terminal device 20 does not have knowledge of base stations that might be disabled. In this case, the terminal device 20 can presume that there might be base stations in the neighborhood, which can be waked up, activated or enabled. Hence, it may perform a different idle mode procedure as described below, if a signal quality of a broadcast channel of a wireless network cell is insufficient, i.e. the terminal device 20 can not receive a DL broadcast channel of available cells with a sufficient signal to interference and noise ratio (SINR). In this case, it may transmit activation information e.g. to all neighboring base stations.

According to a second embodiment, system information including at least the capability information may be broadcasted beforehand, i.e. when the transmitting unit 31 is active. The terminal device 20 can receive this information by means of its receiving unit 22. Thus, it may have a priori knowledge of transmitting units that might be disabled. As a result, it can transmit activation information to those base stations comprising the potentially disabled transmitting units, if a signal quality of the broadcast channel of the wireless network cell is insufficient, i.e. the terminal device 20 may not receive the DL broadcast channel of available cells with a sufficient signal to interference and noise ratio (SINR). That is, the terminal device 20 that has read the capability information at an earlier stage can enter a different idle mode behavior if no suitable cell may be found, i.e. perform the different idle mode procedure as described below. In this case, it can transmit activation information to base stations comprising potentially disabled transmitting units.

According to a third embodiment, the terminal device 20 may try to read the system information if a signal quality of the broadcast channel of the wireless network cell is insufficient, i.e. it can not receive the DL broadcast channel of available cells with a sufficient SINR. In this way, it may get information on possible sleeping or disabled base stations, i.e. transmitting units, in the service area. Then, the terminal device 20 can possibly apply the different idle mode procedure as described in the following.

If the terminal device 20 has read the cell disable capability information, it may store it for a given time, e.g. in a memory of the terminal device 20. The lifetime information can also be stored. As long as the capability information has a valid lifetime, which is indicated by the lifetime information, the idle mode behavior in case that no suitable cells are detected may be modified. That is, the lifetime information indicates how long the capability information is valid, and if it is valid, the terminal device 20 can try to re-activate a sleeping or disabled base station in case that it can not receive the DL broadcast channel of available cells with a sufficient SINR.

As described in further detail below, the terminal device 20 can send an activation information for waking up or re-enabling a disabled (sleeping) base station, i.e. a transmitting unit thereof, if a signal quality of a broadcast channel of a wireless network cell is insufficient. The activation information may be contained e.g. in a RACH message, a RACH burst or a sequence of RACH bursts using specific assigned preamble sequences, i.e. at least one RACH message or burst. It can be at least one specific preamble sequence or preamble sequence set. For example, it may be a specific preamble sequence associated with a specific cell, or a plurality of preamble sequences associated with respective cells.

It should be noted that the RACH preamble format can be predetermined or standardized for cell waking up RACH messages or bursts, e.g. a preamble format 1 or 3 in case of LTE. That is, the at least one specific preamble sequence may conform to a predetermined preamble format of a 3rd generation partnership project long-term evolution standard or another present or future communication standard.

Further, the system information can also comprise information about the transmission power and power ramp up for the waking up or re-activating preambles, i.e. power information. These parameters may be other than for normal RACH messages or bursts, since they will impact a probability that an activation information sent within one disabled cell will be detected also in other disabled cells. That is, a different transmission power and/or power ramp up can be used when transmitting activation information.

After transmitting the activation information, the terminal device 20 may return into a cell reselection stage and search for the waking up cell or base station. The activation information can be received by the still active receiving unit of the sleeping or disabled base station and cause a re-activation of the base station. Then, e.g. a DL signal from the waked up base station may be detected.

In order to prevent that the terminal device 20 transmits an activation information where it is not allowed to do, e.g. the terminal device 20 transmits a LTE RACH message or burst in a country where LTE is not yet deployed, the described procedure can be allowed only if a weak signal of the mobile communication system used by the terminal device 20 can be identified by the terminal device 20. In other words, the detecting unit 24 of the terminal device 20 may be used to detect whether a wireless network supporting to disable the transmitting unit 31 of the base station 30, 40 is available. The activation information can be transmitted only if a suitable wireless network such as e.g. the wireless network 10 has been detected. The detection may be performed e.g. by trying to synchronize to a strongest received cell of the wireless network 10.

In general, a terminal device can permanently monitor a serving cell of a wireless network and neighboring cells. If the serving cell disappears, the terminal device may try to select a next best suitable base station. However, if all next best suitable base stations are considered to be insufficient from a reception quality point of view, a terminal device as previously proposed usually continues to search until it finds a suitable cell.

According to the embodiments, an idle mode behavior of a terminal device such as e.g. the terminal device 20 can be modified. If the terminal device 20 does not find a suitable cell of the wireless network 10, it can send an activation message, activation signal or activation information to a sleeping or disabled cell in order to trigger a re-activation of the same. That is, in a state of no suitable cell being detected and disabled cells existing, the activation information allowing to re-activate or re-enable a disabled cell may be transmitted to such disabled cell.

The prerequisite that cells of a region are synchronized can reduce a computation complexity for a detection of an activation signal. A frame synchronization may provide the terminal device 20 with an a priori knowledge of a frame timing of all cells in the region, derived from a synchronization on any single cell. The terminal device 20 can read a signaling or synchronization channel (SCH). In the specific case where at least some of the base station transmitting units are switched off, the terminal device 20 may measure longer, to derive the slot and frame synchronization with any cell of the region. The frame timing does not have to be perfect, because the RACH messages or bursts can have an extended cyclic prefix in order to cope with different transmission delay times due to an unknown position of the terminal device 20. Further, since the cell is in sleeping mode or disabled mode, there is in principle no other user that can be disturbed.

If a cell search of the terminal device 20 has been unsuccessful for a specific time, the terminal device 20 may perform a different idle mode procedure such as e.g. a wake up RACH procedure. This can be done if a cell disabled cell indicator such as e.g. the capability information was received and the information has a valid lifetime. However, as described above with reference to the first embodiment, the terminal device 20 may also perform a different idle mode procedure without having received such information. Then, the terminal device 20 can enter a mode for reading an available weak SCH, if needed with an extended correlation time frame.

After achieving synchronization, i.e. reading the SCH of a cell, the terminal device 20 may try to read the BCH of this cell. If it determines that the BCH can not be detected, the terminal device 20 may now send an activation information. For example, a wake up RACH message utilizing an assigned group of preamble sequences for sleeping or disabled base stations such as e.g. node Bs can be transmitted.

The receiver or receiving unit in a transmit (TX) disabled base station such as e.g. the receiving unit 32 of the base station 30, 40 may still be active for the UL. This means for the terminal device 20 that in practice no modification to a normal TX operation is needed. The base station 30, 40 in receive (RX) only mode can receive the activation information such as a RACH message or burst that has been sent in the usual transmission form of the wireless network 10. As described above, only the used preamble indicates the wake up RACH message nature.

Thus, no signal of a special form and no specific receiver device in the base station 30, 40 are needed. The usual RACH format may be used. This is due to the fact that there is no need for an extended range, because the receiver of the disabled cell, i.e. the receiving unit 32 of the disabled base station 30, 40, is still active and can detect the wake up RACH message.

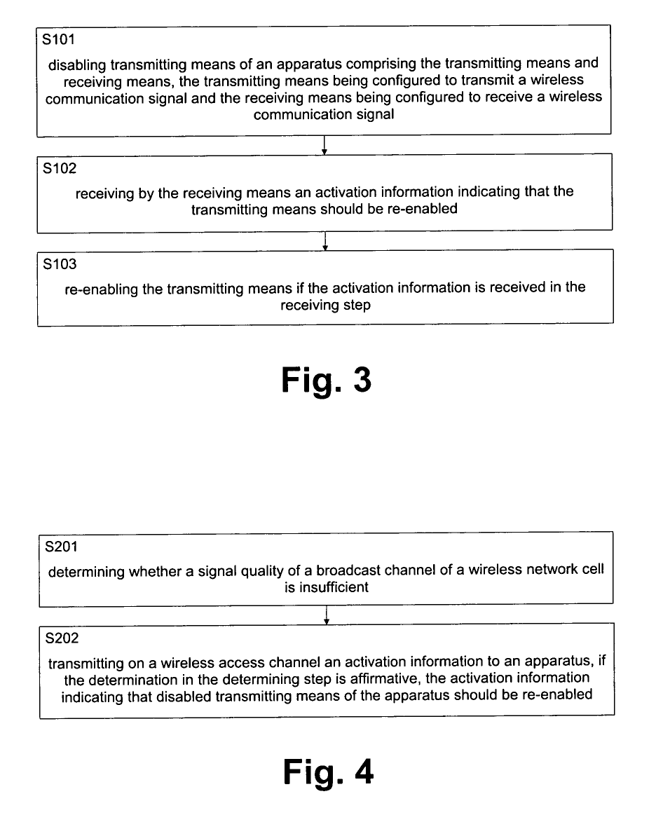

FIG. 3 shows a flow diagram of a basic processing at an apparatus 30, 40 such as e.g. a base station according to the embodiments. In a step S101, the transmitting means 31 of the apparatus 30, 40 comprising the transmitting means 31 and the receiving means 32 can be disabled, wherein the transmitting means 31 may be configured to transmit a wireless communication signal and the receiving means 32 can be configured to receive a wireless communication signal. In a step S102, an activation information indicating that the transmitting means 31 should be re-enabled may be received by the receiving means 32. In a step S103, the transmitting means 31 can be re-enabled if the activation information is received in the receiving step S102.

FIG. 4 shows a flow diagram of a basic processing at an apparatus 20 such as e.g. a terminal device according to the embodiments. In a step S201, it may be determined whether a signal quality of a broadcast channel of a wireless network cell is insufficient. In a step S202, an activation information can be transmitted on a wireless access channel to an apparatus 30, 40, if the determination in the determining step S201 is affirmative, the activation information indicating that disabled transmitting means 31 of the apparatus 30, 40 should be re-enabled.

As described above, a terminal such as e.g. the apparatus 20 may be informed by means of system information communicated on e.g. the BCCH about the existence of sleeping or disabled base stations such as e.g. the apparatuses 30, 40 and the activation information to be used by the terminal or apparatus 20. For example, specific assigned RACH preamble sequences that are exclusively used by terminals can be communicated. In case of using a RACH burst as an example of the activation information and a user equipment (UE) as an example of the apparatus 20, the re-activation or wake up procedure for the UE that does not get connected to an active base station can be described as follows:
UE detects that a “correct mobile communication system” is available
UE does synchronization to a strongest received cell
UE notices that a BCH of this strongest cell can not be decoded or is not received with sufficient signal quality
UE transmits a RACH burst from a sleeping base station set (possibly with limited power ramp up)
UE waits for a DL signal from a waked up base station to appear (if not, it repeats the transmission of the sleeping RACH burst a predefined number of times), synchronizes to an appearing cell, and reads normal mode RACH parameters
UE transmits a normal mode RACH message, entering a normal RACH procedure

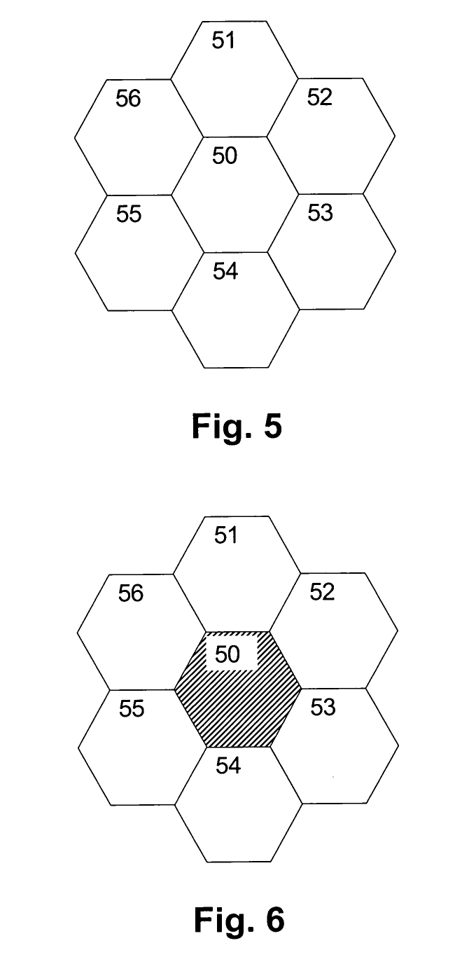

The above procedure is illustrated in FIG. 5 to FIG. 8. FIG. 5 shows a schematic diagram illustrating cells 50 to 56 of the wireless network 10 in a normal or high load scenario. Transmitting and receiving units of all the cells 50 to 56 are active, i.e. all the cells 50 and 56 are active for both UL and DL. This corresponds to an original cell layout.

FIG. 6 shows a schematic diagram illustrating the cells 50 to 56 of the wireless network 10 in a low load scenario. A transmitting unit of the cell 50 has been disabled. That is, the cell 50 is only active for UL while all the other cells 51 to 56 are active for both UL and DL. This is illustrated by a hatching of the cell 50. Thus, an asymmetric uplink/downlink operation in a low load scenario is possible.

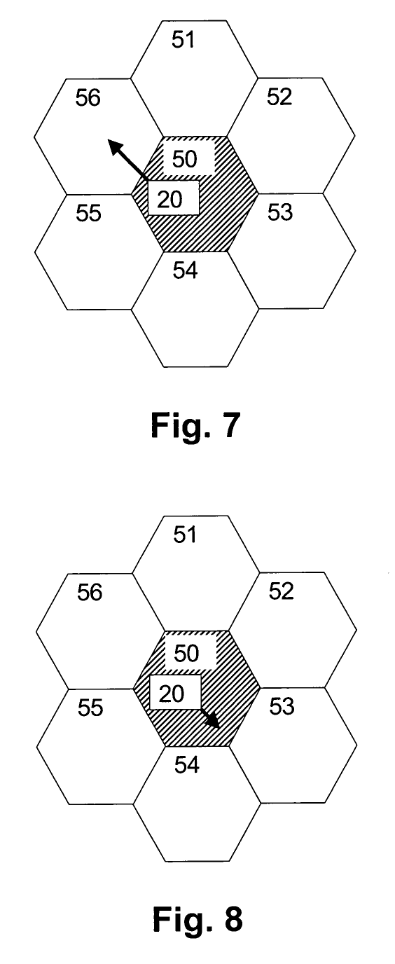

FIG. 7 shows a schematic diagram illustrating a synchronization of the terminal device 20 located in the cell 50 with the disabled transmitting unit. As depicted by an arrow from the terminal device 20 to the cell 56, the terminal device 20 can synchronize to a surrounding cell active for DL, i.e. synchronize with a DL SCH.

FIG. 8 shows a schematic diagram illustrating a transmission of an activation information from the terminal device 20 to the cell 50 with the disabled transmitting unit. As depicted by an arrow from the terminal device 20 to the cell 50, the terminal device 20 may transmit an activation information such as e.g. a RACH burst via the UL to the cell 50 in RX only mode.

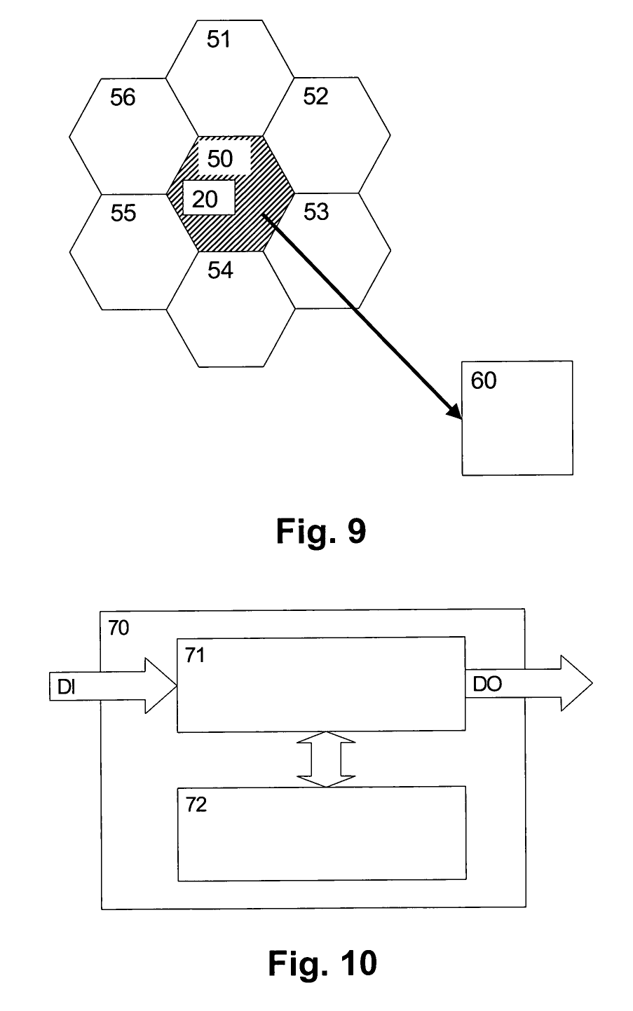

FIG. 9 shows a schematic diagram illustrating a situation where a RX only cell informs an O&M center 60. The base station 30, 40 in RX only mode can have an O&M logical relationship with a software (SW) agent for monitoring a reception of activation information such as wake up RACH signals. The agent may have a threshold that can be configured between e.g. 1 and n. If the number of activation information transmissions received is above the threshold, the agent can activate procedures in the O&M center 60, which in turn can re-activate the disabled base station 30, 40. That is, in this case the disabled base station 30, 40 may not be re-enabled by the activation information transmitted by the terminal device 20, but by actions taken by the O&M center 60. For example, a predetermined message can be used for the procedure between the O&M center 60 and the base station 30, 40.

The embodiments described above enable a standby or idle mode of the base station 30, 40. In this standby mode the base station 30, 40 may disable or turn off its entire transmitter chain in case there is no service requested for a longer time period or it is manually/remotely switched off. The receiver chain of the base station 30, 40 remains activated, and then the base station 30, 40 can be re-activated or waked up by using a cell unique activation information such as e.g. a RACH burst having a specific cell unique RACH preamble sequence.

If the base station 30, 40 is a home enhanced base station such as e.g. a H(e)NB, the terminal device 20 can be registered for the base station 30, 40. A home zone may be defined as a roughly circular region around a location of the base station 30, 40. If the terminal device 20 is located in the home zone, it can use an alternative access technology instead of a wide area (WA) access technology utilized outside of the home zone. For example, wireless local area network (WLAN) access technology may be used in case the terminal device 20 is located in the home zone.

The terminal device 20 can enter a different idle mode behavior (re-activation procedure) if WA fingerprint or global positioning system (GPS) data indicate that its current location is in its home zone but no broadcast signal from the base station 30, 40 can be found. In case of a H(e)NB as an example of the base station 30, 40 and a RACH burst or sequence of RACH bursts as an example of the activation information, the re-activation procedure may be described as follows:
The terminal device 20 detects with WA fingerprint or GPS data that its current location is in its home zone.
The terminal device 20 sends a H(e)NB cell unique RACH burst or a sequence of RACH bursts using specific assigned preamble sequences for reactivation or wake up.
After that the terminal device 20 returns into the cell reselection stage and searches for the waking up cell.

In the above procedure, the RACH burst can be received by the still active receiver of the disabled (sleeping) H(e)NB in the cell of the home zone and may cause a re-activation of the H(e)NB. A H(e)NB cell unique preamble sequence can be planned similar to a downlink scrambling code or even be derived from a physical cell identification. The main reason for using the H(e)NB cell unique preamble sequence is to avoid that sending a RACH message or burst including this preamble sequence results in also re-activating H(e)NBs in neighboring cells (where the terminal device 20 is not member of a subscriber group) at the same time.

With the above procedure, in case of emergency calls a H(e)NB in the standby mode would only wake up if the terminal device 20 is in the home zone and member of the H(e)NB closed subscriber group. Thus, a modification as described in the following may be used so as to enable waking up of a H(e)NB or other base station in an emergency situation.

According to a fourth embodiment, any terminal device can re-activate or wake up base stations such as e.g. H(e)NBs and eNBs in case of an emergency call. This may be achieved by reserving at least one unique activation information in the whole wireless network 10, i.e. at least one network unique activation information, for emergency calls. For example, in case of a LTE or LTE-A network one specific RACH preamble can be reserved in the whole network for emergency calls. In case of a system comprising multiple networks, at least one unique activation information in the whole system, i.e. at least one system unique activation information, may be reserved for emergency calls. For example, a unique emergency activation information could be reserved for a system comprising networks in a certain region such as e.g. Europe or even for a worldwide system including all available networks. The fourth embodiment may be combined with any one of the first to third embodiments.

In the following, the fourth embodiment is described with reference to an eNB and/or H(e)NB as an example of the base station 30, 40. However, this description is merely exemplary. The discussed mechanism may also be applied to base stations other than eNBs and H(e)NBs. For example, it can be used for base stations and sectors that can be switched of by a self-organizing network (SON) procedure, for the sake of energy efficiency.

If in case of an emergency call no WA or H(e)NB network is available, the terminal device 20 may transmit the network or system unique activation information to reactivate or wake up disabled eNBs and H(e)NBs. For example, a network or system specific RACH burst with a specific RACH preamble unique in a whole LTE or LTE-A network can be transmitted. Alternatively, a network or system unique sequence of RACH bursts using specific assigned preamble sequences for emergency wake up may be transmitted.

The different idle mode procedure for re-activating or waking up a H(e)NB or eNB, i.e. its downlink transmitter, if in an emergency case no WA network is seen can be described as follows:
The terminal device 20 sends the network or system unique activation information for emergency re-activation or wake up.
After that the terminal device 20 returns into the cell reselection stage and searches for the waking up cells.

In the above procedure, the activation information may be received by the still active receiver of the disabled (sleeping) H(e)NB or eNB and can cause a reactivation of the H(e)NB or eNB.

The network or system unique activation information may be transmitted with a more aggressive transmission power ramping or a maximum allowed transmission power. That is, the transmission power ramping procedure can be different from that of other transmissions, e.g. have a more aggressive power ramping. For example, a RACH power ramping procedure may be different e.g. with a more aggressive ramping, or a maximum allowed RACH preamble emergency power can always be utilized.

In case of using a LTE or LTE-A system specific RACH burst as an example of the network or system unique activation information and a UE as an example of the terminal device 20, the emergency re-activation or wake up procedure for the UE can be described as follows:
UE detects no WA network and no H(e)NB with sufficient signal strength for service available
UE transmits a system specific RACH burst (possible with maximum allowed RACH preamble power for emergency calls and no power ramping procedure)
UE waits for a DL signal from a waked up H(e)NB and/or eNB to appear

### Either:

UE synchronizes to an appearing cell and reads normal mode RACH parameters
UE transmits a normal mode RACH message (entering a normal RACH procedure)

### Or:

UE synchronizes to an appearing cell
UE transmits a system specific RACH burst (possible with maximum allowed RACH preamble power for emergency calls and no power ramping procedure)
NB transmits an acknowledgement indicator
UE sends RACH message part

Thus, other than with the “normal” re-activation or wake up procedure described in connection with the first to third embodiments, the terminal device 20 can transmit an activation information even without previously detecting that a “correct mobile communication system” is available. That is, in the normal re-activation or wake up procedure the activation information may be only transmitted if a weak signal of the mobile communication system used by the terminal device 20 can be identified by the terminal device 20. For example, the terminal device 20 may try to detect at least a weak LTE or LTE-A signal from the environment. If there is no weak LTE or LTE-A signal detected, the terminal device 20 can not be allowed to transmit an activation information such as e.g. a wake up RACH message. In this way, it may be prevented that the terminal device 20 transmits the activation information where it is not allowed to do, e.g. in a country where LTE is not yet deployed.

On the other hand, in an emergency case the terminal device 20 can be allowed to transmit an emergency activation information such as an emergency RACH message if only a weak signal such as e.g. a LTE or LTE-A signal or even no signal at all from the environment can be found. Thus, in the emergency case the terminal device 20 may transmit e.g. a LTE signal even in an environment where it is not clear if this is allowed. For example, in the emergency case the terminal device 20 can transmit an emergency wake up RACH message even in a country where LTE is not yet deployed. Hence, the normal re-activation or wake up procedure and the emergency re-activation or wake up procedure performed in the terminal device 20 may differ from each other.

According to a first option of the fourth embodiment, a single network or system unique emergency activation information can be defined for emergency calls. In case that the terminal device 20 transmits such activation information, multiple base stations may wake up. This can lead to lots of changes regarding handover borders etc.

Thus, according to a second option of the fourth embodiment, more than one unique emergency activation information may be reserved for emergency calls, and neighboring sleeping nodes can react on different emergency activation information. For example, multiple RACH sequences may be reserved, and neighboring sleeping nodes can react on different sequences. Wake up RACH sequences may be planned e.g. like downlink scrambling codes in node B downlink transmissions, which wake up RACH sequences are applicable for a specific area. This can avoid that all sleeping neighboring nodes would wake up.

If the terminal device 20 is registered at a home base station, home node B or any other type of home access device (in the following referred to as “HNB”), it can know for the conventional RACH which is the HNB wake up sequence. This home RACH wake up sequence may be calculated from a physical cell identification of the HNB to ensure that RACH wake up sequences of neighboring HNBs are different from each other. This can utilize the fact that downlink scrambling codes of neighboring cells and, therefore, physical cell identifications are different from each other.

According to a fifth embodiment based on the fourth embodiment, the terminal device 20 can first search through all access technologies that it is capable of. For example, the terminal device 20 may search through different radio access technologies (RATs) that it is capable of. In case of e.g. a terminal device 20 capable of UMTS communications and WLAN communications, the terminal device 20 can first try to receive a signal with any of these technologies.

If the terminal device 20 can not find a good candidate or even can find no signal at all with any one of the access technologies that it is capable of, it may transmit an emergency activation information. For example, if no good candidate is found or no signal is found on all RATs the terminal device 20 is capable of, the terminal device 20 can transmit an emergency RACH message.

According to the fourth and fifth embodiments, an apparatus such as e.g. the terminal device 20 may be capable of sending an eNB and/or H(e)NB wake up system specific RACH signal in an emergency case and where the apparatus can not connect to another available active WA base station. Thus, in case of an emergency call it may be possible to re-activate an eNB or H(e)NB that is in a standby mode, even if the terminal device 20 initiating the emergency call is not in a home zone of the eNB or H(e)NB and member of its closed subscriber group. Hence, eNBs and/or H(e)NBs can be re-activated or waked up in an emergency situation, while electromagnetic radiation from such base stations and power consumption may be reduced during service inactivity by means of an efficient standby mode.

FIG. 10 shows a schematic block diagram of a software-based implementation of the embodiments. The required functionalities can be implemented in a processing unit 70, which may be any processor or computer device with a control unit 71 that performs control based on software routines of a control program stored in a memory 72. The control program may also be stored separately on a computer-readable medium. Program code instructions can be fetched from the memory 72 and loaded into the control unit 71 of the processing unit 70 in order to perform the processing steps of the above functionalities of the embodiments, which may be implemented as the above-mentioned software routines. The processing steps can be performed on the basis of input data DI and may generate output data DO. At the network side the input data DI may correspond e.g. to an activation information indicating that a disabled transmitting unit of a base station such as e.g. the transmitting unit 31 of the base station 30, 40 should be re-enabled. The output data DO can correspond e.g. to a DL signal from the re-enabled transmitting unit 31. At the terminal device side the input data DI may correspond e.g. to a capability information indicating that disabled base stations may be available. The output data DO can correspond to the activation information.

Thus, the above embodiments may be implemented as a computer program product comprising code means for performing each individual processing step when run on a computer device or data processor of the apparatus 10 or the apparatuses 30, 40.

By the above-described principle e.g. an improvement of a node B power consumption in a UMTS system may be achieved by switching off the transceiver chains. This is possible due to a modified initial random access procedure. A whole transmission of a base station can be shut down in this way, resulting in a reduced power consumption and, therefore, a reduced OPEX and an improved eco-balance.

The above embodiments are at least partially described with reference to 3GPP LTE and LTE-A, and they may be advantageous for future wireless networks, where automated configuration and optimization are of concern to reduce a total cost of ownership for operators of the networks and the network behavior in emergency situations is also of concern. However, the use of the described principle in existing technologies is not precluded, but can be possible based on parameters and procedures of the existing technology, interfaces and architecture. With both of present and future technologies operational costs may be saved in times and areas with low load, by re-configuring base station sites in order to minimize energy consumptions while still providing a sufficient coverage and service.

The present invention is applicable to frequency division duplex (FDD) and time division duplex (TDD) technologies. It may be applied in connection with research body activities like the system of cellular radio for traffic efficiency and safety (SOCRATES), or operator initiatives like next generation mobile networks (NGMN).

It is apparent that the present invention can easily be extended to any communication system with varying load. Specifically, the present invention is not intended to be restricted to the described communication technologies. The embodiments may thus vary within the scope of the attached claims. Furthermore, while the embodiments have been described mainly for the case of a terminal device 20 and base stations 30, 40, other devices can take the respective role as well.

In summary, the present invention relates to methods, apparatuses, a system and a computer program product for reducing a power consumption in low load scenarios. An apparatus 20 can comprise transmitting means 21, receiving means 22 and determining means 23 for determining whether a signal quality of a broadcast channel of a wireless network cell is insufficient, wherein the transmitting means 21 may transmit on a wireless access channel an activation information to a further apparatus 30, 40 if the determination is affirmative. The activation information can indicate that disabled transmitting means 31 of the further apparatus 30, 40 should be re-enabled. The further apparatus 30, 40 may comprise transmitting means 31, receiving means 32, disabling means 33 for disabling the transmitting means 31 and enabling means 34 for re-enabling the transmitting means 31, wherein the receiving means 32 can be configured to receive the activation information, and wherein the enabling means 34 may be configured to re-enable the transmitting means 31 if the activation information is received.

The invention can also be implemented in accordance with the following aspects.

According to a first aspect, a method may comprise: disabling a transmitting unit of an apparatus comprising the transmitting unit and a receiving unit, the transmitting unit being configured to transmit a wireless communication signal and the receiving unit being configured to receive a wireless communication signal; receiving by the receiving unit an activation information indicating that the transmitting unit should be re-enabled; and re-enabling the transmitting unit if the activation information is received in the receiving step.

According to a second aspect, the method according to the first aspect can comprise: broadcasting a capability information indicating that the transmitting unit is capable of being disabled.

According to a third aspect, the method according to the second aspect may comprise: broadcasting a lifetime information defining how long the capability information is valid.

According to a fourth aspect, the method according to any one of the preceding aspects can comprise: broadcasting the activation information, the activation information being a unique activation information of the apparatus or a common activation information of a plurality of apparatuses.

According to a fifth aspect, the method according to any one of the preceding aspects may comprise: broadcasting an attempt information indicating how long and intense a further apparatus should try to transmit the activation information to the apparatus.

According to a sixth aspect, the method according to any one of the preceding aspects can comprise: broadcasting a power information indicating at least one of a transmission power and power ramp up for transmitting the activation information.

According to a seventh aspect, a method may comprise: determining whether a signal quality of a broadcast channel of a wireless network cell is insufficient; and transmitting on a wireless access channel an activation information to an apparatus, if the determination in the determining step is affirmative, the activation information indicating that a disabled transmitting unit of the apparatus should be re-enabled.

According to an eighth aspect, the method according to the seventh aspect can comprise: receiving a capability information indicating that the transmitting unit of the apparatus is capable of being disabled, wherein the activation information is transmitted in the transmitting step if the capability information is received in the receiving step.

According to a ninth aspect, the method according to the eighth aspect may comprise: receiving a lifetime information defining how long the capability information is valid, wherein the activation information can be transmitted if the capability information is valid.

According to a tenth aspect, in the method according to the eighth or ninth aspect the capability information can be received if the determination in the determining step is affirmative.

According to an eleventh aspect, the method according to any one of the seventh to tenth aspects may comprise: receiving an attempt information indicating how long and intense it should be tried to transmit the activation information to the apparatus.

According to a twelfth aspect, the method according to any one of the seventh to eleventh aspects can comprise: trying to receive a signal from the apparatus; and repeating the transmission of the activation information for a certain number of times if no signal from the apparatus has been received after a certain period of time.

According to a thirteenth aspect, the method according to any one of the seventh to twelfth aspects may comprise: receiving a power information indicating at least one of a transmission power and power ramp up for transmitting the activation information, wherein the activation information may be transmitted by using the power information.

According to a fourteenth aspect, the method according to any one of the seventh to thirteenth aspects can comprise: detecting whether a wireless network supporting to disable the transmitting unit of the apparatus is available; and synchronizing to a strongest received cell of the wireless network if the detection in the detecting step is affirmative, wherein it may be determined in the determining step whether a signal quality of a broadcast channel of the strongest received wireless network cell is insufficient.

According to a fifteenth aspect, in the method according to any one of the seventh to fourteenth aspects, the activation information can be transmitted with a more aggressive transmission power ramping or a maximum allowed transmission power.

According to a sixteenth aspect, in the method according to any one of the preceding aspects, the activation information can be contained in at least one random access channel message or burst.

According to a seventeenth aspect, in the method according to any one of the preceding aspects, the activation information may be at least one specific preamble sequence of an access channel message or burst.

According to an eighteenth aspect, in the method according to any one of the preceding aspects, the activation information can conform to a predetermined format of a 3rd generation partnership project long-term evolution standard.

According to a nineteenth aspect, in the method according to any one of the preceding aspects, the activation information can be a unique activation information reserved in a whole network for emergency calls.

According to a twentieth aspect, an apparatus may comprise: a transmitting unit configured to transmit a wireless communication signal; a receiving unit configured to receive a wireless communication signal; a disabling unit configured to disable the transmitting unit; and an enabling unit configured to re-enable the transmitting unit, wherein the receiving unit can be configured to receive an activation information indicating that the transmitting unit should be re-enabled, and wherein the enabling unit may be configured to re-enable the transmitting unit if the activation information is received by the receiving unit.

According to a twenty-first aspect, in the apparatus according to the twentieth aspect, the transmitting unit can be configured to broadcast a capability information indicating that the transmitting unit is capable of being disabled.

According to a twenty-second aspect, in the apparatus according to the twenty-first aspect, the transmitting unit may be configured to broadcast a lifetime information defining how long the capability information is valid.

According to a twenty-third aspect, in the apparatus according to any one of the twentieth to twenty-second aspects, the transmitting unit can be configured to broadcast the activation information, the activation information being a unique activation information of the apparatus or a common activation information of a plurality of apparatuses.

According to a twenty-fourth aspect, in the apparatus according to any one of the twentieth to twenty-third aspects, the transmitting unit may be configured to broadcast an attempt information indicating how long and intense a further apparatus should try to transmit the activation information to the apparatus.

According to a twenty-fifth aspect, in the apparatus according to any one of the twentieth to twenty-fourth aspects, the transmitting unit can be configured to broadcast a power information indicating at least one of a transmission power and power ramp up for transmitting the activation information.

According to a twenty-sixth aspect, an apparatus may comprise: a transmitting unit configured to transmit a wireless communication signal; a receiving unit configured to receive a wireless communication signal; and a determining unit configured to determine whether a signal quality of a broadcast channel of a wireless network cell is insufficient, wherein the transmitting unit can be configured to transmit on a wireless access channel an activation information to a further apparatus, if the determination of the determining unit is affirmative, the activation information indicating that a disabled transmitting unit of the further apparatus should be re-enabled.

According to a twenty-seventh aspect, in the apparatus according to the twenty-sixth aspect, the receiving unit may be configured to receive a capability information indicating that the transmitting unit of the further apparatus is capable of being disabled, and the transmitting unit can be configured to transmit the activation information if the capability information has been received by the receiving unit.

According to a twenty-eighth aspect, in the apparatus according to the twenty-seventh aspect, the receiving unit may be configured to receive a lifetime information defining how long the capability information is valid, and the transmitting unit can be configured to transmit the activation information if the capability information is valid.

According to a twenty-ninth aspect, in the apparatus according to the twenty-seventh or twenty-eighth aspect, the receiving unit may be configured to receive the capability information if the determination of the determining unit is affirmative.

According to a thirtieth aspect, in the apparatus according to any one of the twenty-sixth to twenty-ninth aspects, the receiving unit can be configured to receive an attempt information indicating how long and intense the apparatus should try to transmit the activation information to the further apparatus.

According to a thirty-first aspect, in the apparatus according to any one of the twenty-sixth to thirtieth aspects, the receiving unit may be configured to try to receive a signal from the further apparatus, and the transmitting unit can be configured to repeat the transmission of the activation information for a certain number of times if no signal from the further apparatus has been received by the receiving unit after a certain period of time.

According to a thirty-second aspect, in the apparatus according to any one of the twenty-sixth to thirty-first aspects, the receiving unit may be configured to receive a power information indicating at least one of a transmission power and power ramp up for transmitting the activation information, and the transmitting unit can be configured to transmit the activation information by using the power information.

According to a thirty-third aspect, the apparatus according to any one of the twenty-sixth to thirty-second aspects may comprise: a detecting unit configured to detect whether a wireless network supporting to disable the transmitting unit of the further apparatus is available, wherein the receiving unit can be configured to synchronize to a strongest received cell of the wireless network if the detection of the detecting unit is affirmative, and wherein the determining unit may be configured to determine whether a signal quality of a broadcast channel of the strongest received wireless network cell is insufficient.

According to a thirty-fourth aspect, in the apparatus according to any one of the twenty-sixth to thirty-third aspects, the transmitting means can be configured to transmit the activation information with a more aggressive transmission power ramping or a maximum allowed transmission power.

According to a thirty-fifth aspect, in the apparatus according to any one of the twentieth to thirty-fourth aspects, the activation information can be contained in at least one random access channel message or burst.

According to a thirty-sixth aspect, in the apparatus according to any one of the twentieth to thirty-fifth aspects, the activation information may be at least one specific preamble sequence of an access channel message or burst.

According to a thirty-seventh aspect, in the apparatus according to any one of the twentieth to thirty-sixth aspects, the at least one specific preamble sequence can conform to a predetermined preamble format of a 3rd generation partnership project long-term evolution standard.

According to a thirty-eighth aspect, in the apparatus according to any one of the twentieth to thirty-seventh aspects, the activation information can be a unique activation information reserved in a whole network for emergency calls.

According to a thirty-ninth aspect, a computer-readable storage medium may be encoded with instructions that, when executed by a computer, perform: disabling a transmitting unit of an apparatus comprising the transmitting unit and a receiving unit, the transmitting unit being configured to transmit a wireless communication signal and the receiving unit being configured to receive a wireless communication signal; receiving by the receiving unit an activation information indicating that the transmitting unit should be re-enabled; and re-enabling the transmitting unit if the activation information is received in the receiving step.

According to a fortieth aspect, a computer-readable storage medium can be encoded with instructions that, when executed by a computer, perform: determining whether a signal quality of a broadcast channel of a wireless network cell is insufficient; and transmitting on a wireless access channel an activation information to an apparatus, if the determination in the determining step is affirmative, the activation information indicating that a disabled transmitting unit of the apparatus should be re-enabled.

According to a forty-first aspect, a system may comprise: at least one apparatus according to any one of the twentieth to twenty-fifth aspects or any one of the thirty-fifth to thirty-eighth aspects if dependent on any one of the twentieth to twenty-fifth aspects; and an operation and maintenance center comprising an agent for monitoring a reception of the activation information, wherein the agent is configured to count a number of receptions of the activation information, and to activate procedures in the operation and maintenance center for re-enabling the transmitting unit of the at least one apparatus if the counted number is above a certain threshold.

According to a forty-second aspect, a base station device can comprise an apparatus according to any one of the twentieth to twenty-fifth aspects or any one of the thirty-fifth to thirty-eighth aspects if dependent on any one of the twentieth to twenty-fifth aspects.

According to a forty-third aspect, a mobile terminal device may comprise an apparatus according to any one of the twenty-sixth to thirty-fourth aspects or any one of the thirty-fifth to thirty-eighth aspects if dependent on any one of the twenty-sixth to thirty-fourth aspects.

According to a forty-fourth aspect, a chip device can comprise an apparatus according to any one of the twentieth to thirty-eighth aspects.

1. A method comprising:
disabling transmitting means of an apparatus comprising said transmitting means and receiving means, said transmitting means being configured to transmit a wireless communication signal and said receiving means being configured to receive a wireless communication signal;
receiving by said receiving means an activation information indicating that said transmitting means should be re-enabled; and
re-enabling said transmitting means if said activation information is received in said receiving step.

2. The method according to claim 1, comprising:
broadcasting a capability information indicating that said transmitting means is capable of being disabled.

3. The method according to claim 2, comprising:
broadcasting a lifetime information defining how long said capability information is valid.

4. The method according to claim 1, comprising:
broadcasting said activation information, said activation information being a unique activation information of said apparatus or a common activation information of a plurality of apparatuses.

5. The method according to claim 1, comprising:
broadcasting an attempt information indicating how long and intense a further apparatus should try to transmit said activation information to said apparatus.

6. The method according to claim 1, comprising:
broadcasting a power information indicating at least one of a transmission power and power ramp up for transmitting said activation information.

7. A method comprising:
determining whether a signal quality of a broadcast channel of a wireless network cell is insufficient; and
transmitting on a wireless access channel an activation information to an apparatus, if said determination in said determining step is affirmative, said activation information indicating that disabled transmitting means of said apparatus should be re-enabled.

8. The method according to claim 7, comprising:
receiving a capability information indicating that said transmitting means of said apparatus is capable of being disabled,
wherein said activation information is transmitted in said transmitting step if said capability information is received in said receiving step.

9. The method according to claim 8, comprising:
receiving a lifetime information defining how long said capability information is valid,
wherein said activation information is transmitted if said capability information is valid.

10. The method according to claim 8,
wherein said capability information is received if said determination in said determining step is affirmative.

11. The method according to claim 7, comprising:
receiving an attempt information indicating how long and intense it should be tried to transmit said activation information to said apparatus.

12. The method according to claim 7, comprising:
trying to receive a signal from said apparatus; and
repeating said transmission of said activation information for a certain number of times if no signal from said apparatus has been received after a certain period of time.

13. The method according to claim 7, comprising:
receiving a power information indicating at least one of a transmission power and power ramp up for transmitting said activation information,
wherein said activation information is transmitted by using said power information.

14. The method according to claim 7, comprising:
detecting whether a wireless network supporting to disable said transmitting means of said apparatus is available; and
synchronizing to a strongest received cell of said wireless network if said detection in said detecting step is affirmative,
wherein it is determined in said determining step whether a signal quality of a broadcast channel of said strongest received wireless network cell is insufficient.

15. The method according to claim 7,
wherein said activation information is transmitted with a more aggressive transmission power ramping or a maximum allowed transmission power.

16. The method according to claim 7,
wherein said activation information is contained in at least one random access channel message or burst.

17. The method according to claim 1,
wherein said activation information is at least one specific preamble sequence of an access channel message or burst.

18. The method according to claim 1,
wherein said activation information conforms to a predetermined format of a 3rd generation partnership project long-term evolution standard.

19. The method according to claim 1,
wherein said activation information is a unique activation information reserved in a whole network for emergency calls.

20. An apparatus comprising:
transmitting means for transmitting a wireless communication signal;
receiving means for receiving a wireless communication signal;
disabling means for disabling said transmitting means; and
enabling means for re-enabling said transmitting means,
wherein said receiving means is configured to receive an activation information indicating that said transmitting means should be re-enabled, and
wherein said enabling means is configured to re-enable said transmitting means if said activation information is received by said receiving means.

21. The apparatus according to claim 20,
wherein said transmitting means is configured to broadcast a capability information indicating that said transmitting means is capable of being disabled.

22. The apparatus according to claim 21,
wherein said transmitting means is configured to broadcast a lifetime information defining how long said capability information is valid.

23. The apparatus according to claim 20,
wherein said transmitting means is configured to broadcast said activation information, said activation information being a unique activation information of said apparatus or a common activation information of a plurality of apparatuses.

24. The apparatus according to claim 20,
wherein said transmitting means is configured to broadcast an attempt information indicating how long and intense a further apparatus should try to transmit said activation information to said apparatus.

25. The apparatus according to claim 20,
wherein said transmitting means is configured to broadcast a power information indicating at least one of a transmission power and power ramp up for transmitting said activation information.

26. An apparatus comprising:
transmitting means for transmitting a wireless communication signal;
receiving means for receiving a wireless communication signal; and
determining means for determining whether a signal quality of a broadcast channel of a wireless network cell is insufficient,
wherein said transmitting means is configured to transmit on a wireless access channel an activation information to a further apparatus, if said determination of said determining means is affirmative, said activation information indicating that disabled transmitting means of said further apparatus should be re-enabled.

27. The apparatus according to claim 26,
wherein said receiving means is configured to receive a capability information indicating that said transmitting means of said further apparatus is capable of being disabled, and
wherein said transmitting means is configured to transmit said activation information if said capability information has been received by said receiving means.

28. The apparatus according to claim 27,
wherein said receiving means is configured to receive a lifetime information defining how long said capability information is valid, and
wherein said transmitting means is configured to transmit said activation information if said capability information is valid.

29. The apparatus according to claim 27,
wherein said receiving means is configured to receive said capability information if said determination of said determining means is affirmative.

30. The apparatus according to claim 26,
wherein said receiving means is configured to receive an attempt information indicating how long and intense said apparatus should try to transmit said activation information to said further apparatus.

31. The apparatus according to claim 26,
wherein said receiving means is configured to try to receive a signal from said further apparatus, and
wherein said transmitting means is configured to repeat said transmission of said activation information for a certain number of times if no signal from said further apparatus has been received by said receiving means after a certain period of time.

32. The apparatus according to claim 26,
wherein said receiving means is configured to receive a power information indicating at least one of a transmission power and power ramp up for transmitting said activation information, and
wherein said transmitting means is configured to transmit said activation information by using said power information.

33. The apparatus according to claim 26, comprising:
detecting means for detecting whether a wireless network supporting to disable said transmitting means of said further apparatus is available,
wherein said receiving means is configured to synchronize to a strongest received cell of said wireless network if said detection of said detecting means is affirmative, and
wherein said determining means is configured to determine whether a signal quality of a broadcast channel of said strongest received wireless network cell is insufficient.

34. The apparatus according to claim 26,
wherein said transmitting means is configured to transmit said activation information with a more aggressive transmission power ramping or a maximum allowed transmission power.

35. The apparatus according to claim 20,
wherein said activation information is contained in at least one random access channel message or burst.

36. The apparatus according to claim 20,
wherein said activation information is at least one specific preamble sequence of an access channel message or burst.

37. The apparatus according to claim 20,
wherein said at least one specific preamble sequence conforms to a predetermined preamble format of a 3rd generation partnership project long-term evolution standard.

38. The apparatus according to claim 20,
wherein said activation information is a unique activation information reserved in a whole network for emergency calls.

39. A computer program product comprising code means for performing the steps of the method according to claim 1 when run on a computer device.

40. A system comprising:
at least one apparatus to any claim 20; and
an operation and maintenance center comprising an agent for monitoring a reception of said activation information,
wherein said agent is configured to count a number of receptions of said activation information, and to activate procedures in said operation and maintenance center for re-enabling said transmitting means of said at least one apparatus if said counted number is above a certain threshold.

41. A base station device comprising an apparatus according to claim 20.

42. A mobile terminal device comprising an apparatus according to claim 26.

43. A chip device comprising an apparatus according to claim 20.
